(19) United States
(12) Patent Application Publication
(10) Pub. No.: US 2011/0155309 A1
(43) Pub. Date: Jun. 30, 2011

(54) METHOD FOR MANUFACTURING FLAT MOLDED MEMBERS OR FILMS

(75) Inventors: Helmut Steininger, Worms (DE); Cecile Gibon, Mannheim (DE); Martin Weber, Maikammer (DE); Thomas Breiner, Laudenbach (DE); Walter Heckmann, Weinheim (DE); Hans-Helmut Goertz, Freinsheim (DE)

(73) Assignee: BASF SE, Ludwigshafen (DE)

(21) Appl. No.: 13/062,595

(22) PCT Filed: Sep. 2, 2009
(86) PCT No.: PCT/EP2009/061344

§ 371 Date: Mar. 7, 2011

(30) Foreign Application Priority Data
Sep. 8, 2008 (EP) 08163852.0

(51) Int. Cl. B29C 47/00; B32B 38/00

(52) U.S. Cl. 156/244.11; 264/210.1; 264/555

(57) ABSTRACT

Sheet-like moldings or foils with anisotropic coefficients of thermal expansion are produced from extrudable thermoplastic polymer molding compositions by filling the thermoplastic polymer molding compositions with lamellar phyllosilicates whose diameter is in the range from 10 to 1000 nm and whose aspect ratio is in the range from 1:5 to 1:10 000 and extruding the filled thermoplastic polymer molding compositions, and then monoaxially or biaxially orienting the extrudate to give sheet-like moldings or foils.

The invention relates to processes for the production of sheet-like moldings or foils with anisotropic coefficients of thermal expansion, composed of extrudable thermoplastic polymer molding compositions.

Components composed of thermoplastics have numerous advantages over parts manufactured from metal, but also significant disadvantages. Among the advantages are low density, leading to a marked saving in weight, easy processing by injection molding, permitting a high level of design flexibility, inherent corrosion resistance, meaning that there is no need for any specific corrosion-prevention measure, and easy integration of plastics components into metal structures. On the disadvantages side there is inter alia low dimensional stability, attributable to the often high level of water absorption, and to low heat resistance (temperature dependency of stiffness), and to high coefficients of thermal expansion (CTE) of the polymers, and the manufacturing problems deriving therefrom. Specifically in automobile construction, bodywork components composed of a plastic can at best be processed only inline rather than, as desired, online, and indeed generally can only be processed offline, meaning that these components have to be assembled at the end of the paint line. This is attended not only by additional costs by also by colormatching problems.

The order of magnitude of the CTEs of metals is 10*10⁻⁶ K⁻¹, while that of polymers below the glass transition temperature (T_{g}) is 100*10⁻⁶ K⁻¹, i.e. higher by a factor of 10. While the CTE of metals is substantially independent of temperature, that of polymers increases by a further factor of from two to three once T_{g} has been exceeded.

It is known that lamellar inorganic fillers, such as phyllosilicates, can be used as filler in polymer molding compositions.

WO 2006/029138 relates to the production of water-soluble polyamide compositions which can be further processed to give films and foils. Phyllosilicates can be used concomitantly here. For the production process, an alcoholic solution of the polymer is mixed with phyllosilicates and cast to give films or foils. The foils can be used in the packaging industry.

JP-A-57083551 relates to vermiculite-filled polyamide resin compositions with improved properties in relation to hardness and length increase. To this end, vermiculite whose aspect ratio is >5 is introduced into nylon-6,6 and injection-molded. Various coefficients of thermal expansion were measured in the direction of extrusion and perpendicularly thereto.

Polymer 43 (2002), pages 6727 to 6741 describes the thermal expansion behavior of nylon-6 nanocomposites. To this end, phyllosilicates were incorporated into nylon-6, and the molding compositions were extruded. The extrusion process led to moldings with coefficients of thermal expansion which were different for the three spatial directions. This led to the conclusion of non-statistical orientation of the delaminated phyllosilicates.

However, the fortuitous and therefore undefined orientation obtained in previous processes of the phyllosilicates, and the associated anisotropy of the coefficient of thermal expansion are not adequate for applications which require a reduced coefficient of thermal expansion in two spatial directions. Products to which this applied included in particular those produced by injection molding with wall thickness less than 1 mm.

The object of the invention was a considerable reduction in the thermal expansion of polymeric materials and, respectively, moldings, at temperatures including those above the glass transition temperature. Since the three-dimensional components on which interest is focused are subject to tight tolerances for length and width, CTE has to be reduced in two dimensions. Changes in the third dimension, the thickness of the component, are less relevant or irrelevant. The modifications that have to be made to the material for this purpose, or to the constitution of the blend or compounded material in which it is present, are preferably intended not to have any attendant reduction in toughness, i.e. any embrittlement of the material.

The invention achieves the object via a process for the production of sheet-like moldings or foils with anisotropic coefficients of thermal expansion, composed of extrudable thermoplastic polymer molding compositions, by filling the thermoplastic polymer molding compositions with lamellar phyllosilicates whose diameter is in the range from 10 to 1000 nm and whose aspect ratio is in the range from 1:5 to 1:10 000, extruding the filled thermoplastic polymer molding compositions, and then monoaxially or biaxially orienting the extrudate to give sheet-like moldings or foils.

It has been found according to the invention that use of monoaxial or biaxial orientation of the extrudate which by this stage has been preoriented through shear and strain through the extrusion die, giving a sheet-like molding or a foil, it is possible to achieve an adequately high level of orientation of the phyllosilicates, the result being that the coefficient of thermal expansion in the plane of the major surface is small, whereas perpendicularly to the major surface it is high. This gives access to moldings or foils in which CTE has been reduced in two dimensions.

In principle, reduction of CTE here can be achieved by using inorganic compounds whose thermal expansion is small in comparison with that of polymers. If these compounds are compounded homogeneously in powder form into a polymer, CTE decreases in compliance with a mixing rule, and linear and isotropically with the concentration of the filler. Since the CTE of the fillers is about 10*10⁻⁶ K⁻¹, if known methods are used the filler concentrations required to achieve significant effects are very high, and these have an adverse effect on mechanical properties, namely the toughness of the material. Surprisingly, it has been found that if the particles used are preferably very thin, and lamellar, i.e. “two-dimensional”, even low concentrations could achieve a large reduction in CTE, if these materials have maximum homogeneity of dispersion in the polymer matrix, and have maximum planar orientation. In addition, a significant increase in stiffness (modulus of elasticity) and heat resistance was found with these materials, but hardly any reduction in toughness. The lamellar fillers used preferably comprise organomodified montmorillonites (MMT), which give good results in exfoliation and dispersion.

Any desired suitable processes can be used to achieve the monoaxial or biaxial orientation of the extrudate to give sheet-like moldings or foils. According to one embodiment of the invention, the extrusion process preferably takes place from a slot die with subsequent monoaxial or biaxial orientation of the extruded foil. According to another embodiment of the invention, the extrusion process preferably takes place from an annular die with subsequent biaxial orientation via blowing or blow molding. The person skilled in the art is aware of appropriate processes and appropriate apparatuses and die geometries.

To obtain higher layer thicknesses, the extruded and oriented moldings or foils can be stacked, for example while hot, or laminated. This step of the process does not adversely affect either the dispersion or the orientation of the filler. The lamination process can be omitted if the molten sublayers produced in a coextrusion process are mutually superposed. A calender stage can follow in order to calibrate the layer thickness, or treatment in a stretching frame can follow in order to increase orientation.

An advantage of foil technology here is the flexibility of combination of materials. Films with low CTE can be combined with films whose functional properties are important for the completed product, examples being diffusion barrier, toughness, flame retardancy, optical properties, etc.

It is possible to produce a composite by combining at least one phyllosilicate-filled foil with at least one other thermoplastic foil serving, for example, for property modification, e.g. with regard to diffusion barrier or to impact resistance. The foil stack can be produced via coextrusion, and there is the possibility here of adding further film sublayers or film stacks via lamination.

The molding or foils can subsequently be used to produce moldings via impact extrusion processes or via thermoforming. These moldings are in particular used in automobile construction. Exterior bodywork parts such as wheel surrounds, engine hoods, doors, and tailgates, are particularly relevant here, as also are motor-vehicle-interior fittings.

For the purposes of the present invention, the expression “sheet-like molding” means a molding mainly extending in two dimensions and extending only to a small extent into a third dimension. By way of example, the length and width of the molding can each be at least 10×, preferably at least 20×, as great as the thickness of the molding:

The expression “anisotropic coefficients of thermal expansion” means that a molding has, in at least one of the three spatial directions, a coefficient of thermal expansion which differs from that in the other spatial direction. Preferred moldings or foils of the present invention have an increased coefficient of thermal expansion perpendicularly to the major surface, and within the major surface have a coefficient of thermal expansion reduced in comparison with that of an unfilled polymer.

The expression “lamellar” for phyllosilicates means that, with a diameter in the range from 10 nm to 1000 nm, their aspect ratio is in the range from 1:5 to 1:10 000.

The subsequent monoaxial or biaxial orientation of the extrudate in the process preferably leads to an orientation ratio in the range from 1:1 to 1:20, particularly preferably in the range from 1:2 to 1:8.

Any desired suitable lamellar phyllosilicates can be used in the process of the invention. The diameter of preferred phyllosilicates is in the range from 15 nm to 500 nm, in particular from 20 nm to 500 nm. The aspect ratio here is preferably from 1:5 to 1:1000, in particular from 1:10 to 1:100. The layer thickness is preferably less than 50 nm, particularly preferably less than 10 nm, in particular less than 2 nm.

The phyllosilicates can be based on any desired silicates, for example on montmorillonites, on aluminum silicates, on magnesium silicates, on bentonites, on vermiculites, etc. Other suitable phyllosilicates are hectorite, saponite, beidellite, and nontronite.

Suitable phyllosilicates are described in the literature listed in the introduction. Other suitable phyllosilicates are described in WO 2008/063198 and U.S. Pat. No. 5,747,560.

The phyllosilicates can be untreated or organomodified phyllosilicates. It is preferable to use organomodified phyllosilicates. This type of organomodification is described by way of example in WO 2008/063198. To this end, the phyllosilicates are reacted with organic compounds which have an end group which is compatible with the polymer of the thermoplastic molding composition, and which also have an anchor group for binding to the phyllosilicate.

It is preferable that the phyllosilicate is modified through a cation-exchange reaction with a suitable organic salt, such as a quaternary ammonium-, phosphonium- or imidazolium salt. Suitable quaternary ammonium salts preferably correspond to the general formula R¹R²R³R⁴N⁺, in which R¹ to R⁴, independently of one another, are linear, branched, or aromatic hydrocarbon radicals. Phosphorus can also be present instead of nitrogen in the cations. WO 2008/063198 describes suitable modifications.

The hydrocarbon radicals can moreover have modification by hydroxy groups or by acid groups.

By way of example, a quaternary ammonium counter ion can have a methyl group, two hydroxy methyl groups, and a group derived from tallow (C₁₄₋₁₈ radical).

Amino acids in protonated form can moreover also be used as cations, examples being C₆₋₁₄ amino acids. Suitable phyllosilicates are obtainable by way of example from Rockwood Additives (Southern Clay Products). It is also possible by way of example to use Arginotech phyllosilicates from B+M Nottenkamper Gesellschaft für Bergbau und Mineralstoffe mbH und Co. KG.

The amount of the phyllosilicates can be adjusted in accordance with practical requirements. The proportion in the thermoplastic polymer molding compositions usually amounts to from 0.1% to 10% by weight, preferably from 1% to 5% by weight, based on the entire polymer molding composition.

The amount depends on the level of dispersion of the phyllosilicates in the polymer molding compositions. If the phyllosilicate is added to the finished polymer molding composition and, for example, admixed in an extruder, the selected amount will have to be higher than for mixing to incorporate the phyllosilicate into a monomer mixture before production of the polymer has ended.

This is attributable to the fact that incorporation in an extruder, for example in a twin-screw extruder, cannot achieve dispersion as homogeneous as that during in-situ polymerization. As the dispersion and exfoliation of the phyllosilicates becomes better, the amounts used can become smaller.

According to the invention it is also possible to add additional, further inorganic fillers to the thermoplastic polymer molding composition. These fillers in particular involve particulate fillers, and in particular involve talc. The amount of the further fillers used is preferably in the range from 0.1% by weight to 10% by weight, particularly preferably from 0.5% by weight to 5% by weight.

The amount used concomitantly of further inorganic fillers can preferably be up to 5% by weight, based on the polymer molding composition.

The thermoplastic polymer molding composition can be selected from any desired suitable thermoplastic polymer molding compositions. It is preferable that the underlying thermoplastic polymer has been selected from polyamides, polyoxymethylene, polyalkylene terephthalate, such as polyethylene terephthalate or polybutylene terephthalate, polysulfones, polyolefins, such as polyethylene or polypropylene, polystyrenes, polyethers, polyesters, or polymethyl (meth)acrylates, or from copolymers, or from mixtures of these, which can also comprise rubbers. The polymers may have been impact-modified. It is particularly preferable to use polyamides and their blends with PC, ABS, etc.

The production of the thermoplastic polymers is well known. The polymers can also comprise further ingredients, examples being light stabilizers and heat stabilizers, dyes, mold-release agents, flame retardants, etc. Concomitant use of fibrous fillers is also possible, examples being glass fibers or carbon fibers.

The melt viscosities of the thermoplastic polymers preferably used are preferably in the range from 50 Pas to 3500 Pas.

In the production process, the extrusion process preferably takes place at temperatures in the range from 220° C. to 280° C. In the orientation process, the polymer foils or films preferably retain a temperature in the range from 70° C. to 200° C.

The invention also provides moldings or foils obtainable by one of the processes described above.

In the case of foils, the layer thickness is preferably from 50 μm to 300 μm. For laminates or moldings composed of a plurality of foils, the thickness is preferably from 1 mm to 4 mm.

The moldings or foils of the invention are in particular used in automobile construction.

The examples below provide further explanation of the invention.

### EXAMPLES

Thermoplastic molding compositions based on polyamide and organomodified montmorillonites (MMT) were used.

### Homogeneous Dispersion

For homogeneous dispersion of the MMTs, two routes were used. The MMTs can be dispersed with good results in a thermoplastic polymer via direct compounding in a twin-screw extruder (an example being PA6/MMT-1). Better dispersion of the MMTs, and consequently more efficient effect of the particles, were found in products polymerized in-situ with caprolactam (e.g. PA6/MMT-2).

### Orientation of the Filler

In thin-walled products of thickness less than 1 mm, produced by injection molding, the orientation of the MMTs proved inadequate and impossible to adjust in a defined manner. In contrast, the desired planar orientation could be achieved in foils produced via extrusion from a slot die and subsequent monoaxial or biaxial orientation. This also applies to blown foils, the usual production process for which uses extrusion of a melt from an annular die and subsequent biaxial orientation (blowing). The typical thickness of the foils is below 300 μm.

Since the wall thicknesses of actual components are in the region of a few millimeters, individual foil sublayers in stacks were hot-laminated or produced by a coextrusion process. This step of the process does not have any adverse effect on either dispersion or orientation of the filler. The measured CTE values cited in the inventive examples were determined on the semifinished products composed of securely fused foil stacks produced in this way.

### Starting Material

### Component A

A1: Nylon-6 whose intrinsic viscosity IV is 150 ml/g, measured in the form of a 0.5% strength by weight solution in 96% strength by weight sulfuric acid at 25° C. to ISO 307
A2: An in-situ-polymerized nylon-6, produced as follows: (production of component A in the presence of component B)

1 kg of the phyllosilicate B2 is dissolved or suspended in 19 kg of caprolactam and 0.2 kg of water. After addition of 10 g of propionic acid and 5 l of water, the mixture is heated to 270° C. in a stirred tank, the internal pressure in the tank being 17 bar.

After precondensation for one hour, the vessel used is depressurized over a period of 2 hours and then the mixture is post-condensed for 1 hour. The melt is discharged from the tank and pelletized. The pellets are extracted with hot water for 24 hours, dried, and then heat-conditioned at 180° C. for 22 hours.

The starting material has the following properties:

IV=163 ml/g
AEG=32 mmol/kg
CEG=104 mmol/kg

### Component B

B1: Cloisite 30B® (Southern Clay Products, Gonzales, Tex., USA) phyllosilicate hydrophobicized with quaternary ammonium salt.
B2: SCPX 1304® (Southern Clay Products, Gonzales, Tex., USA) phyllosilicate hydrophobicized with quaternary C₁₂ amino acid.

### Component C

C1: IT Extra® talc (Norwegian Talc, Bad Soden, DE)

### Component D

D1: Irganox 670® (Ciba Specialty Chemicals, CH)

### Inventive Example 1 (P1)

Component A1 is used in combination with 5% by weight of component B1. Component D1 is added at a concentration of 0.2% by weight. The PA6 nanocomposite is compounded at 250° C. by means of a Werner & Pfleiderer ZSK25 twin-screw extruder. All of the components here are premixed, and the premix is charged to the extruder intake. The resultant compounded material is pelletized.

Foils are produced via extrusion on a blown-film plant (Weber). The screw diameter of the extruder is 50 mm. The extruder is operated at 50 rpm with a throughput of 5.4 kg/h, at from 240° C. (zone 1) to 260° C. (zone 3).

The blowing ratio is 1:2, and the take-off speed is 4.8 m/min. The thickness of the resultant foil is about 50 μm. This foil is used to produce thick test specimens. The plurality of foils are stacked to give a total thickness of 6 mm and laminated under 3 bar at 225° C. for 9 minutes. The resulting product (called P1) has a thickness of 5 mm and is used for further characterization tests.

### Inventive Example 2 (P2)

Component A2 is diluted with component A1 until the concentration of component B2 is 2% strength by weight, and is further mixed with 2% by weight of component Cl and with 0.2% by weight of component D1. The PA6 nanocomposite is compounded at 250° C. by means of a ZSK 25 twin-screw extruder. All of the components here are premixed, and the premix is charged to the extruder intake. The resultant compounded material (called P2) is pelletized.

Foils are produced via extrusion on a blown-film plant (Weber). The screw diameter of the extruder is 50 mm. The extruder is operated at 50 rpm with a throughput of 5.4 kg/h, at from 240° C. (zone 1) to 260° C. (zone 3). The blowing ratio is 1:2, and the take-off speed is 5 m/min. The thickness of the resultant foil is about 50 μm. This foil is used to produce a thick part. The plurality of foils are stacked together to give a total thickness of 6 mm, and laminated under 3 bar at 225° C. for 9 minutes. The resulting product (called P2) has a thickness of about 5 mm, and is used for further characterization.

### Inventive Example 3 (P3)

Component A2 is used in the form of pure product. Foils are produced via extrusion on a flat-foil plant (Weber, ZE30). The extruder is operated at 75 rpm and at from 230° C. (temperature of the first barrel section), 240° C. (temperature of die), and then 250° C. (center of extruder). Take-off speed is 4.2 m/min. The resultant foil has a thickness of about 200 μm. This foil is used to produce thick test specimens. The plurality of foils are stacked to give a total thickness of 6 mm and laminated under 3 bar at 225° C. for 9 minutes. The resulting product (called P3) has a thickness of 5 mm and is used for further characterization tests.

### Comparative Example 1 (P4)

Component A1 is used in the form of pure product. Foils are produced via extrusion on a flat-foil plant (Weber, ZE30). The extruder is operated at 75 rpm and at from 230° C. (temperature of the first barrel section and of the die), and then 250° C. (center of extruder). Take-off speed is 4.2 m/min. The resultant foil has a thickness of about 250 μm. This foil is used to produce thick test specimens. The plurality of foils are stacked to give a total thickness of 6 mm and laminated under 3 bar at 225° C. for 9 minutes. The resulting product (called P4) has a thickness of 5 mm and is used for further characterization tests.

### Comparative Example 2 (P5)

Component A1 is used in combination with 5% by weight of component B1. Component D1 is added at a concentration of 0.2% by weight. The PA6 nanocomposite is compounded at 250° C. by means of a ZSK 25 twin-screw extruder. All of the components here are premixed and added to the extruder intake. The resultant compounded material is pelletized. The dry pellets are processed at a melt temperature of 260° C. in an injection-molding machine to give tensile specimens measuring 60 mm×10 mm×0.8 mm, the mold temperature here being 35° C.

### Determination of CTE (Coefficient of Thermal Expansion)

CTEs are determined in the three directions (flow direction, transverse direction, and across the thickness) in a TMA-SS6000 device from Seiko. The surface of the specimen is first ground to give a smooth surface. The specimen is inserted into the measurement cell and, before being measured, heated to 140° C. in order to ensure that it is dry. The CTEs are then in each case measured using a heating rate of 1 K/min under a load of 20 mN in the temperature range from −40° C. to 120° C.

The results are stated as average value when they are based on a temperature range. Two temperature ranges are distinguished: for temperatures below T_{g} (from −40° C. to about 40° C.) and for temperatures above T₉ (from about 40° C. to 120° C.). CTE at 120° C. was also determined.

| | | | P1 | P2 | P3 | P4 | P5 |
|---|---|---|---|---|---|---|---|
| Component | A1 | | 94.8 | 57.8 | 0 | 100 | 94.8 |
| | A2 | | 0 | 40 | 100 | 0 | 0 |
| | B1 | | 5 | 0 | 0 | 0 | 5 |
| | B2 | | 0 | 5% in A2 | 5% in A2 | 0 | 0 |
| | C1 | | 0 | 2 | 0 | 0 | 0 |
| | D1 | | 0.2 | 0.2 | 0 | 0 | 0.2 |
| Processing | | | blown | blown | extruded | extruded | fire test specimen |
| | | | foil | foil | foil | foil | (injection molding) |
| CTE | −40° C. < T < Tg | F | 59 | 44 | 41 | 68 | 62 |
| (10⁻⁶ · K⁻¹) | | T | 57 | 51 | 45 | 73 | 51 |
| | | P | 95 | 116 | 112 | 85 | 101 |
| | Tg < T < 120° C. | F | 81 | 39 | 49 | 110 | 100 |
| | | T | 83 | 51 | 61 | 114 | 63 |
| | | P | 208 | 250 | 214 | 155 | 220 |
| | T = 120° C. | F | 88 | 36 | 49 | 121 | 108 |
| | | T | 91 | 49 | 63 | 134 | 65 |
| | | P | 253 | 308 | 268 | 199 | 266 |

| | | | | | | |
|---|---|---|---|---|---|---|
| CVE | −40° C. < T < Tg | 211 | 211 | 198 | 226 | 214 |
| (10⁻⁶ · K⁻¹) | Tg < T < 120° C. | 373 | 340 | 323 | 378 | 383 |
| | T = 120° C. | 432 | 393 | 381 | 455 | 439 |

F designates CTE measured in flow direction,
T designates CTE measured in transverse direction (transversal with respect to flow direction, in the plane of the foil), and
P designates CTE measured perpendicularly with respect to the plane of the foil (across the thickness of a foil).

1.-12. (canceled)

13. A process for the production of sheet-like moldings with anisotropic coefficients of thermal expansion, composed of extrudable thermoplastic polymer molding compositions, the process comprising:
filling the thermoplastic polymer molding compositions with lamellar phyllosilicates whose diameter is in the range from 10 to 1000 nm and whose aspect ratio is in the range from 1:5 to 1:10 000,
extruding the filled thermoplastic polymer molding compositions, and then
monoaxially or biaxially orienting the extrudate to give sheet-like moldings or foils, wherein the extruded and oriented moldings or foils are stacked or laminated, in order to increase layer thickness, and the moldings are subsequently produced via impact extrusion processes or via thermoforming.

14. The process according to claim 13, wherein the extrusion takes place from a slot die with subsequent monoaxial or biaxial orientation.

15. The process according to claim 13, wherein the extruding takes place from an annular die with subsequent biaxial orientation, via blowing.

16. The process according to claim 13, wherein the lamellar phyllosilicates have been organomodified.

17. The process according to claim 13, wherein the thermoplastic polymer molding compositions are filled with the lamellar phyllosilicate prior to or during the production of the polymer from monomers.

18. The process according to claim 13, wherein the thermoplastic polymer of the thermoplastic polymer molding composition has been selected from polyamides, polyoxymethylenes, polyalkylene terephthalates, polysulfones, polyolefins, polystyrenes, polyethers, polyesters, or polymethyl (meth)acrylates, or from copolymers, or from mixtures of these, which can also comprise rubbers.

19. The process according to claim 13, wherein the thermoplastic polymer molding compositions also comprise further inorganic fillers.

20. The process according to claim 13, wherein at least one phyllosilicate-filled foil is combined with at least one other thermoplastic foil to give a composite.

21. The process according to claim 13, wherein a foil stack is produced via coextrusion.

22. The process according to claim 20, wherein further foil sublayers or foil stacks are added via lamination to the foil stack.
